(19) United States
(12) Patent Application Publication
(10) Pub. No.: US 2018/0309652 A1
(43) Pub. Date: Oct. 25, 2018

(54) MOBILE DEVICES AND METHODS FOR DETERMINING A DATA TRANSMISSION RATE OF A NETWORK THEREOF

(71) Applicant: Acer Incorporated, New Taipei City (TW)

(72) Inventors: Chia-Hsun LEE, New Taipei City (TW); Chao-Kuang YANG, New Taipei City (TW); Cheng-Kang CHAO, New Taipei City (TW); Cheng-Hung CHEN, New Taipei City (TW); Chi-Hung CHANG, New Taipei City (TW)

(21) Appl. No.: 15/955,942

(22) Filed: Apr. 18, 2018

(30) Foreign Application Priority Data
Apr. 24, 2017 (TW) 106113590

(51) Int. Cl. H04L 12/26; H04L 1/00; H04W 8/00

(52) U.S. Cl. CPC H04L 43/0894; H04L 1/0002; H04W 8/005; H04L 43/16; H04L 43/10

(57) ABSTRACT

A method and mobile device determine a data transmission rate of a network applied to the mobile device. The mobile device comprises a first network element and a second network element for connecting to a first network and a second network, respectively. The method includes detecting a plurality of broadcast signals from a plurality of target devices of the first network via the first network element, determining the number of the target devices based on the detected broadcast signals, and determining whether a data transmission rate corresponding to the second network is set to a first data transmission rate or a second data transmission rate adjusted from the first data transmission rate according to a determination of whether the number of the target devices meets a predetermined condition and performing data transmission in the second network with the determined data transmission rate via the second network element.

### CROSS REFERENCE TO RELATED APPLICATIONS

This Application claims priority of Taiwan Application No. 106113590, filed on Apr. 24, 2017, the entirety of which is incorporated by reference herein.

### FIELD OF THE INVENTION

The invention relates to network management techniques, and more precisely, to mobile devices supporting multiple networks and methods for determining a data transmission rate of a network thereof.

### DESCRIPTION OF THE RELATED ART

In recent years, portable devices, such as mobile or handheld devices, have become more and more advanced technology and having versatility. For example, the mobile device can receive e-mail messages, phone book has an advanced management application that allows multimedia playback, and has a variety of other functions. As these devices have the convenience versatile, making these devices indispensable in life.

In addition, with the rapid progress of science and technology and the Internet, information technology has grown rapidly, leading to a greater emphasis on Internet of Things (IoT) development and cloud computing. IoT which can constitute a Thing-to-Thing interconnected Internet is an important development line for the current industry. For some applications of IoTs, such as in a use scenario of IoT teaching devices used in the classroom, multiple groups of IoT devices and mobile devices may be used in the same field at the same time, and these IoT devices and mobile devices may continuously communicate through the network for data transmission. However, due to limited network bandwidth, too many devices send data at the same time may lead to bandwidth congestion, making the network speed slow and unstable.

Therefore, there is a need for a device and associated method for performing stable data transmission in an environment with limited network bandwidth.

### BRIEF SUMMARY OF THE INVENTION

Mobile devices and methods for determining a data transmission rate of a network thereof are provided

An embodiment of the invention provides a method for determining a data transmission rate of a network applied to a mobile device, wherein the mobile device comprises a first network element and a second network element for connecting to a first network and a second network, respectively. The method includes the steps of: detecting a plurality of broadcast signals from a plurality of target devices of the first network via the first network element; determining the number of the target devices based on the detected broadcast signals; and determining whether a data transmission rate corresponding to the second network is set to a first data transmission rate or a second data transmission rate adjusted from the first data transmission rate according to a determination of whether the number of the target devices meets a predetermined condition and performing data transmission in the second network with the determined data transmission rate via the second network element.

Another embodiment of the present invention provides a mobile device comprising a wireless module and a processor. The wireless module performs wireless signal transmission and reception with a plurality of target devices via a first network and a second network, respectively. The processor is coupled to the wireless module for detecting a plurality of broadcast signals from the target devices of the first network via the wireless module, determining the number of the target devices based on the detected broadcast signals, and determining whether a data transmission rate corresponding to the second network is set to a first data transmission rate or a second data transmission rate adjusted from the first data transmission rate according to a determination of whether the number of the target devices meets a predetermined condition and performing data transmission in the second network with the determined data transmission rate via the wireless module.

Methods may be practiced by the disclosed devices or systems which are suitable firmware or hardware components capable of performing specific functions. Methods may also take the form of a program code embodied in a tangible media. When the program code is loaded into and executed by an electronic device, a processor, a computer or a machine, the electronic device, the processor, the computer or the machine becomes an apparatus for practicing the disclosed method. Other aspects and features of the present invention will become apparent to those with ordinary skill in the art upon review of the following descriptions of specific embodiments of the mobile devices for carrying out the methods for determining a data transmission rate of a network.

### BRIEF DESCRIPTION OF THE DRAWINGS

The invention can be more fully understood by reading the subsequent detailed description and examples with references made to the accompanying drawings, wherein:

FIG. 1 is a schematic diagram illustrating an embodiment of a communication system of the invention;

FIG. 2 is a schematic diagram illustrating an embodiment of a mobile device of the invention;

FIG. 3 is a flowchart of an embodiment of a method for determining the data transmission rate of a network of the invention;

FIG. 4 is a flowchart of another embodiment of a method for determining the data transmission rate of a network of the invention;

FIG. 5 is a flowchart of yet another embodiment of a method for determining the data transmission rate of a network of the invention; and

FIG. 6 is a flowchart of still another embodiment of a method for determining the data transmission rate of a network of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide mobile devices supporting a plurality of networks and methods for determining a data transmission rate of a network thereof, which can determine the data transmission rate of one network based on the degree of network congestion detected from another network and adaptively adjust the transmission speed of data signals, thereby making smooth data transmission under the limited network bandwidth without causing network bandwidth blocking so as to provide stable and rapid network data transmission.

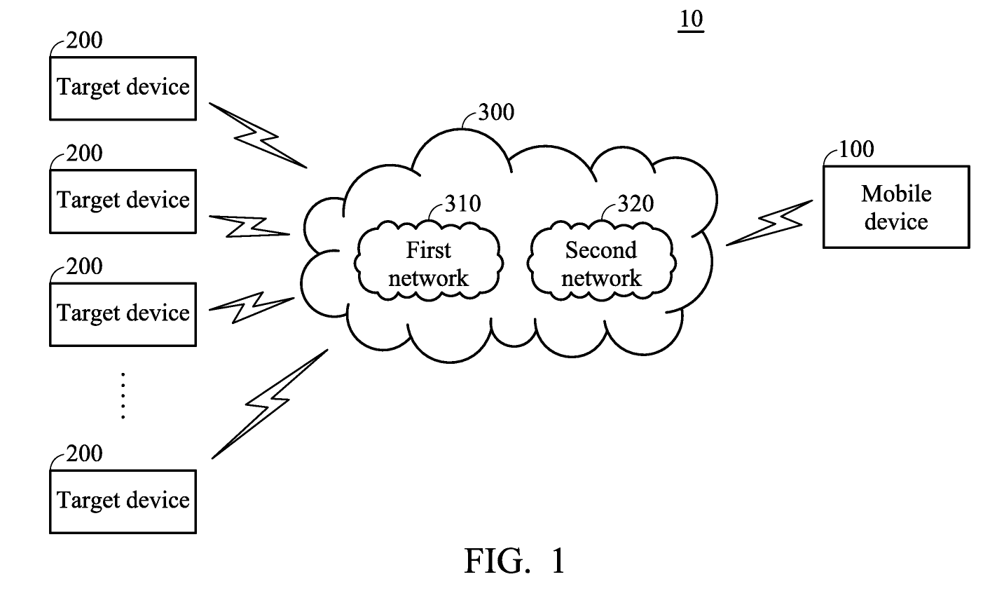

FIG. 1 is a block diagram of a communication system 10 in accordance with an exemplary embodiment of the invention. As shown in FIG. 1, the communication system 10 may comprise one or more mobile devices 100 and one or more target devices 200, wherein the mobile devices 100 and the target devices 200 may be coupled to and communicated with each other via a connected communication network 300 (e.g., any wired/wireless communication networks, such as the Internet, 3G, and/or WLAN network, etc. . . . ). As shown in FIG. 1, the communication network 300 includes at least a first network 310 and a second network 320 in which the mobile devices 100 can perform signal transmission and reception with the target devices 200 via the first network 310 and the mobile devices 100 can also perform signal transmission and reception with the target devices 200 via the second network 320. The first network 310 and the second network 320 are two different networks using different communication protocols, for example, the first network 310 can be a Bluetooth network using a Bluetooth technology and the second network 320 can be a wireless network using a radio accessing technology other than the Bluetooth technology, such as WiFi wireless networks, but the invention is not limited thereto.

In some embodiments, the mobile device 100 can be a portable device or a handheld device supporting various networks, such as a PDA, a smartphone, a mobile phone, a tablet, an Mobile internet device (MID), a laptop computer, a car computer, a digital camera, a multimedia player or a game device, or any other type of mobile computational device, however, it is to be understood that the invention is not limited thereto.

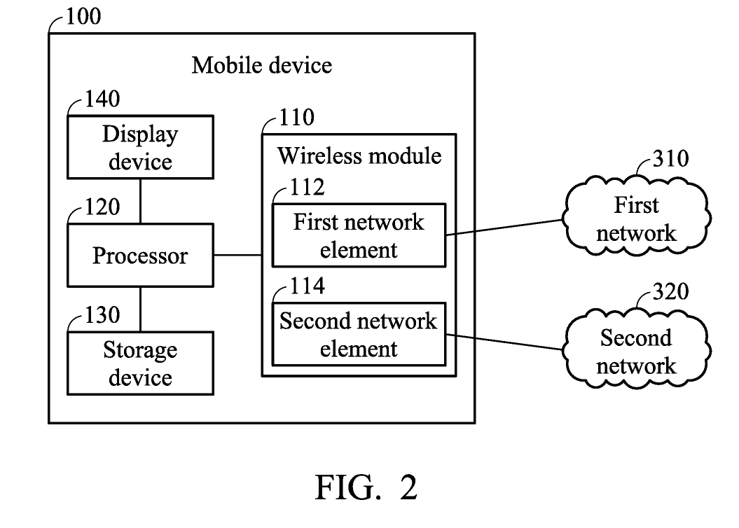

Please refer to FIG. 2. FIG. 2 is a schematic diagram illustrating an embodiment of a mobile device of the invention. As shown in FIG. 2, the mobile device 100 may further comprise a wireless module 110, a processor 120, a storage device 130 and a display device 140. The wireless module 110 receives signals from and transmits signals to a current associated network. It is to be understood that integrating the processor 120 into the wireless module 110 is also possible. The wireless module 110 may be coupled to one or more antennas (not shown) and may allow communications with one or more additional devices, computers and/or servers using a wireless network. The mobile device 100 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto. The wireless module 110 includes at least a first network element 112 and a second network element 114 for connecting to the first network 310 and the second network 320, respectively. Particularly, the first network element 112 uses the same communication protocol as the first network 310, and the second network element 114 uses the same communication protocol as the second network 320. For example, when the first network 310 is the Bluetooth network using Bluetooth technology and the second network 320 is the Wi-Fi wireless network, the first network element 112 is an Bluetooth element compatible with the Bluetooth technology, while the second network element 114 is a wireless network element compatible with the Wi-Fi technology used and so on.

The processor 120 may be one or more data processors, image processors and/or central processors, which are capable of executing one or more types of computer readable medium stored in the storage device 130 such as a memory.

The storage device 130 may be a memory of the mobile device 100 and also may be an external storage card, such as a smart media (SM) card or secure digital (SD) card, for example. The application codes (not shown) stored in the storage device 130 are executed by the processor 120 to control the wireless module 110 and the storage device 130 to perform the method for determining the data transmission rate of the network of the present invention.

The display device 140 is configured to display related data, such as texts, figures, interfaces, and/or related information. It is understood that, in some embodiments, the display device 140 may be integrated with a touch-sensitive device (not shown). The touch-sensitive device has a touch-sensitive surface comprising sensors in at least one dimension to detect contact and movement of at least one object (an input tool), such as a pen/stylus or a finger near or on the touch-sensitive surface. Thus, users can input relevant commands or signals via the screen of the display device 140.

The processor 120 which is coupled to the wireless module 110, the storage device 130 and the display device 140 can control the wireless module 110, the storage device 130 and the display device 140 to perform the method for determining the data transmission rate of the network of the present invention, which will be discussed further in the following paragraphs.

Similarly, the target device 200 may include at least one communication module (not shown), a processor (not shown), and a storage device (not shown). The communication module receives signals from and transmits signals to a current associated network. The communication module may further comprise a wireless module (not shown), which can be coupled to one or more antennas (not shown) and may allow communications with one or more mobile devices 100 using a wireless network. The target device 200 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto. In this embodiment, the communication module of the target device 200 includes at least a network element corresponding to the first network element 112 and a network element corresponding to the second network element 114 for connecting to the first network 310 and the second network 320, respectively, so that the target devices 200 can perform signal transmission and reception with the mobile devices 100 via the first network 310 and the target devices 200 can also perform signal transmission and reception with the mobile devices 100 via the second network 320. The communication module may also continuously transmit a broadcast signal to the first network 310, wherein the broadcast signal may include identification information of the target device 200, such as the media access control address, location information, etc. of the target device 200.

The processor may be a microprocessor which is capable of executing one or more types of computer readable medium stored in the storage device such as a memory. For example, the storage device may store program codes of operating systems such as Linux operating system, Windows operating system or other similar operating system and the program codes of operating systems stored in the storage device can be loaded and executed by the processor to run the operating systems. In other words, the target device 200 may be considered as a small-scale computing means having the ability to operate a specific operating system independently.

In some embodiments, the target device 200 may further include a variety of sensors or detectors, wherein said sensor/detector can be used to collect or measure a variety of sensor data, such as various sensing data related to the environment such as temperature, humidity and so on. The target device 200 may transmit the collected or measured sensor data to a corresponding mobile device 100 after being connected to the corresponding mobile device 100 via a connected network (e.g., the second network 320).

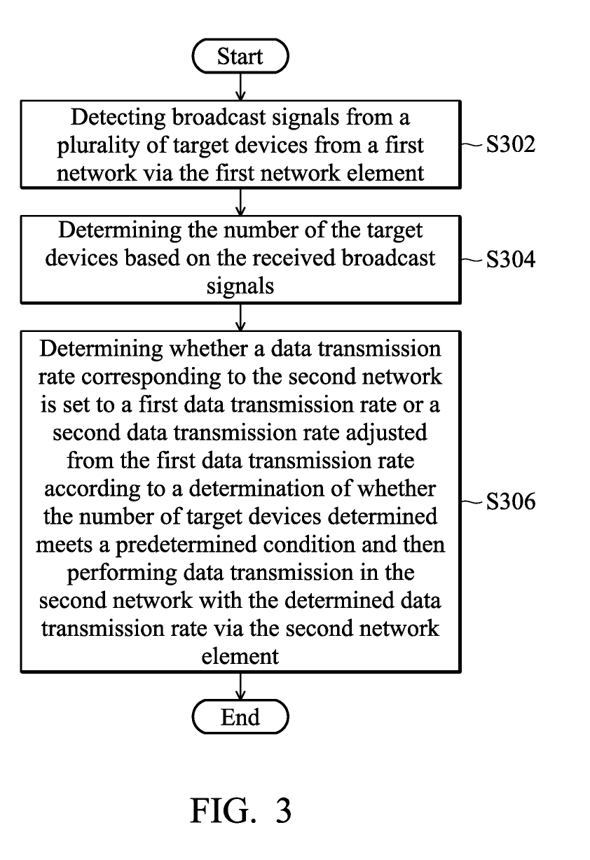

FIG. 3 is a flowchart of an embodiment of a method for determining a data transmission rate of a network of the invention. The method for determining the data transmission rate of the network can be applied to the mobile device 100 as shown in FIG. 2. For example, the method can be performed by the processor 120 of the mobile device 100 as shown in FIG. 2.

First, in step S302, the processor 120 detects broadcast signals from one or more target devices 200 from the first network via the first network element 112 of the wireless module 110. To be more specific, in the embodiments of the present invention, each of the target devices 200 in use will continuously transmit a broadcast signal to the first network 310. In such case, each device continues to send the broadcast signal through a beacon. The beacon can be referred to as any micro-positioning signal transmitter with low-power Bluetooth (BLE or Bluetooth 4.0). In other words, beacon is like a lighthouse that keeps broadcasting the signals. When one mobile device 100 enters the coverage of the lighthouse, the beacon sends a broadcast signal to the mobile device 100, and the mobile device 100 triggers a series of actions after detecting the broadcast signal. The broadcast signal sent from each target device 200 may include identification information corresponding thereto, such as a media access control address and a code of each target device 200, and the like. The mobile device 100 may detect all the broadcast signals via the first network element 112.

Thereafter, in step S304, the processor 120 determines the number of the target devices 200 based on the received broadcast signals. In this step, as the broadcast signal of each target device 200 contains its corresponding identification information, the processor 120 can determine the number of the target devices 200 within the environment based on the number of received broadcast signals. For example, when the processor 120 receives a total of 10 broadcast signals from the first network 310, the processor 120 may determine that the number of target devices 200 is 10. In some embodiments, the mobile device 100 may have a list that includes identification information for all valid target devices, and the processor 120 may refer to this list to filter out other invalid devices to avoid misjudgment. For example, the processor 120 may receive a total of 10 broadcast signals from the first network 310, whereas the identification information of the two broadcast signals is not in the list, so the processor 120 may determine that the number of target devices 200 is 8.

After determining the number of target devices 200, in step S306, the processor 120 determines whether a data transmission rate corresponding to the second network 320 is set to a first data transmission rate or a second data transmission rate adjusted from the first data transmission rate according to a determination of whether the number of target devices determined meets a predetermined condition and then performs data transmission in the second network 320 with the determined data transmission rate via the second network element 114. For example, when the processor 120 determines that the data transmission rate corresponding to the second network 320 is set to the second data transmission rate, the processor 120 may perform the data transmission with a corresponding target device among the target devices 200 in the second network 320, such as sending control commands to the corresponding target device or receiving data (e.g., sensor data) from the corresponding target device or the like, at the second data transmission rate.

To be more specific, the predetermined condition can be utilized to determine whether the current network is jammed (i.e., whether the network bandwidth is enough), which can be generated by the experience rule or manually defined by the user on the basis of the conditions of the environment being used (e.g., an amount of the available bandwidth in the environment, or the performance and bandwidth capacity and other conditions of the gateway device that controls all the devices being currently used).

In one embodiment, the predetermined condition can be a determination of whether the number of target devices is higher than an upper limit, and the step that the processor 120 determines whether the data transmission rate corresponding to the second network 320 is set to the first data transmission rate or the second data transmission rate according to the determination of whether the number of target devices determined meets the predetermined condition may further include the following steps: determining that the data transmission rate corresponding to the second network is set to the first data transmission rate (e.g., the first data transmission rate is of a default rate of 1 kbps) when the number of the target devices 200 is not higher than the upper limit; and decreasing the first data transmission rate to generate the second data transmission rate (e.g., the second data transmission rate is of 0.5 kbps) and determining that the data transmission rate corresponding to the second network is set to the second data transmission rate when the number of the target devices 200 is higher than the upper limit. The value of this upper limit can be generated by the experience rule or manually defined by the user on the basis of the conditions of the environment being used (e.g., an amount of the available bandwidth in the environment, or the performance and bandwidth capacity and other conditions of the gateway device that controls all the devices being currently used). When the number of target devices is higher than the upper limit, it means that the network bandwidth is not enough and thus the data transmission rate must be decreased.

In another embodiment, the predetermined condition may be a determination of whether the number of target devices is lower than a lower limit and the step that the processor 120 determines whether the data transmission rate corresponding to the second network 320 is set to the first data transmission rate or the second data transmission rate according to the determination of whether the number of target devices determined meets the predetermined condition may further include the following steps: determining, by the processor 120, that the data transmission rate corresponding to the second network is set to the first data transmission rate (e.g., the first data transmission rate is of the default rate of 1 kbps) when the number of the target devices is not lower than the lower limit; and increasing, by the processor 120, the first data transmission rate to generate a second data transmission rate (e.g., the second data transmission rate is of 1.5 kbps) and determining that the data transmission rate corresponding to the second network is set to the second data transmission rate when the number of the target devices 200 is lower than the lower limit. The value of this lower limit can be generated by the experience rule or manually defined by the user on the basis of the conditions of the environment being used (e.g., an amount of the available bandwidth in the environment, or the performance and bandwidth capacity and other conditions of the gateway device that controls all the devices being currently used). When the number of target devices is lower than the lower limit, it means that the network bandwidth is enough and thus the data transmission rate can be increased.

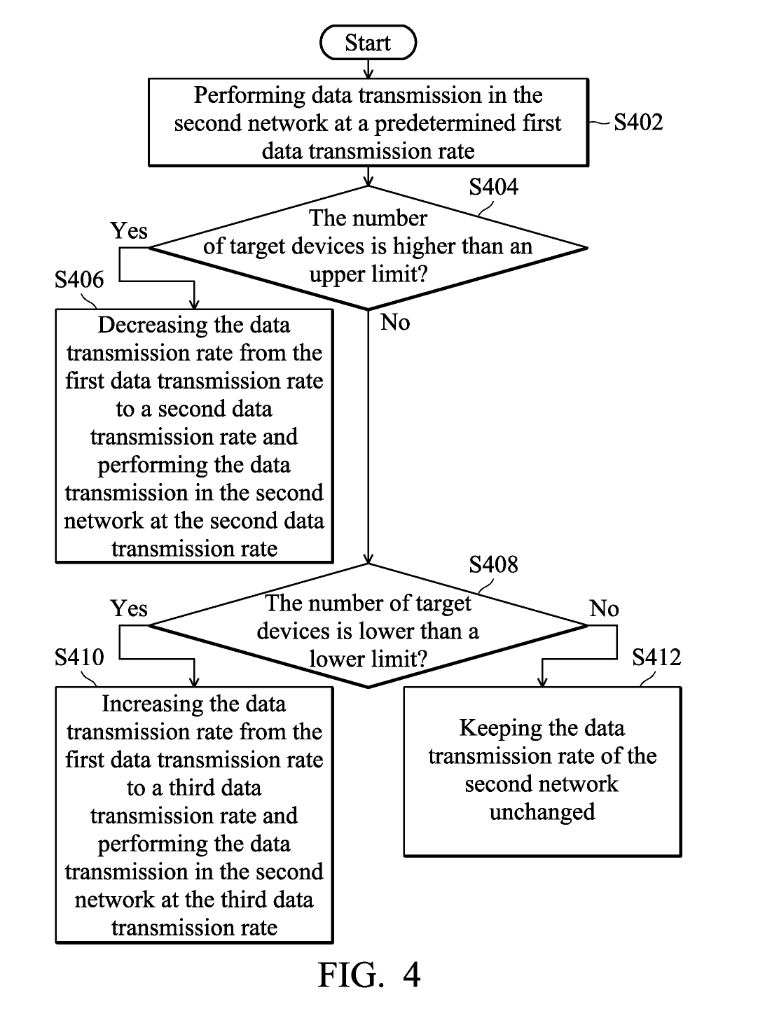

FIG. 4 is a flowchart of another embodiment of the method for determining the data transmission rate of the network of the invention. The method for determining the data transmission rate of the network can be applied to the mobile device 100 as shown in FIG. 2. For example, the method can be performed by the processor 120 of the mobile device 100 as shown in FIG. 2.

When the mobile device 100 prepares to perform data transmission with its corresponding target device 200 through the second network 320, in step S402, the mobile device 100 first performs the data transmission with the corresponding target device 200 through the second network 320 at a predetermined first data transmission rate (e.g., the first data transmission rate is of the default rate of 1 kbps).

During the data transmission process, in step S404, the processor 120 continues to determine whether the number of the target devices 200 is higher than the set upper limit. If the number of target devices 200 is higher than the upper limit (Yes in step S404), it means that the current network bandwidth is not enough and speeding down of the data transmission rate is required. Thus, in step S406, the processor 120 decreases the data transmission rate of the network from the first data transmission rate to a second data transmission rate (e.g., the second data transmission rate is of 0.5 kbps) and performs the data transmission with the corresponding target device 200 through the second network 320 at the second data transmission rate. On the other hand, if the number of the target devices 200 is not higher than the upper limit value (No in step S404), in step S408, the processor 120 then determines whether the number of the target devices 200 is lower than a lower limit. If the number of target devices 200 is lower than the lower limit value (Yes in step S408), it means that the current network bandwidth is enough and thus the data transmission rate of the network can be increased. Thus, in step S410, the processor 120 increases the data transmission rate of the network from the first data transmission rate to a third data transmission rate (e.g., increasing the data transmission rate of the network from the preset 1 kbps to 1.5 kbps) and performs the data transmission with the corresponding target device 200 through the second network 320 at the third data transmission rate. If the number of the target devices 200 is not higher than the upper limit and not lower than the lower limit (No in step S408), it means that it is not necessary to adjust the current data transmission rate, and thus in step S412, the processor 120 keeps the data transmission rate of the second network 320 remaining unchanged. It should be understood that the processor 120 may increase or decrease the data transmission rate in various ways of adjusting, for example, adjusting by a fixed percentage (e.g., a half of or a certain percentage of the increased predetermined data transmission rate) or adjusting by gradually increasing or gradually decreasing (e.g., an increment or an decrement of 10% each time).

Therefore, each mobile device in the environment can use the above-mentioned mechanism to dynamically adjust its own data transmission rate of the network in a timely manner, thereby dynamically adjusting the speed of the instructions transmitted to the target devices, which can effectively increase the number of available devices under the limited bandwidth and can make the data transmission smooth, so as to avoid a variety of problems caused by network congestion.

In some embodiments, after the mobile device 100 has decreased the data transmission rate to perform a slowing-down data transmission, the mobile device 100 may continue to receive Bluetooth identification signals within the environment through the first network element 112 (e.g., a Bluetooth element), determine the change in the number of target devices in use, and determine whether the data transmission rate of the first network 310 (e.g., a Wi-Fi wireless network) can be increased according to the number of target devices in use. Specifically, a lower limit can be set in advance, and when the determined number of target devices being used is lower than the lower limit, it means that the current network bandwidth is enough and a speeding-up data transmission can be performed. The value of the lower limit can be generated by the experience rule or manually defined by the user on the basis of the conditions of the environment being used (e.g., an amount of the available bandwidth in the environment, or the performance and bandwidth capacity and other conditions of the gateway device that controls all the devices being currently used).

In some embodiments, after the mobile device 100 has increased the data transmission rate to perform a speeding-up data transmission, the mobile device 100 may continue to receive Bluetooth identification signals within the environment through the Bluetooth element, determine the change in the number of target devices in use, and determine whether the data transmission rate of the Wi-Fi wireless network should be decreased to perform the slowing-down data transmission according to the number of target devices in use.

For explanation, some specific embodiments are illustrated in the following, and those skilled in the art will understand that these specific embodiments are used for explanation only and the invention is not limited thereto.

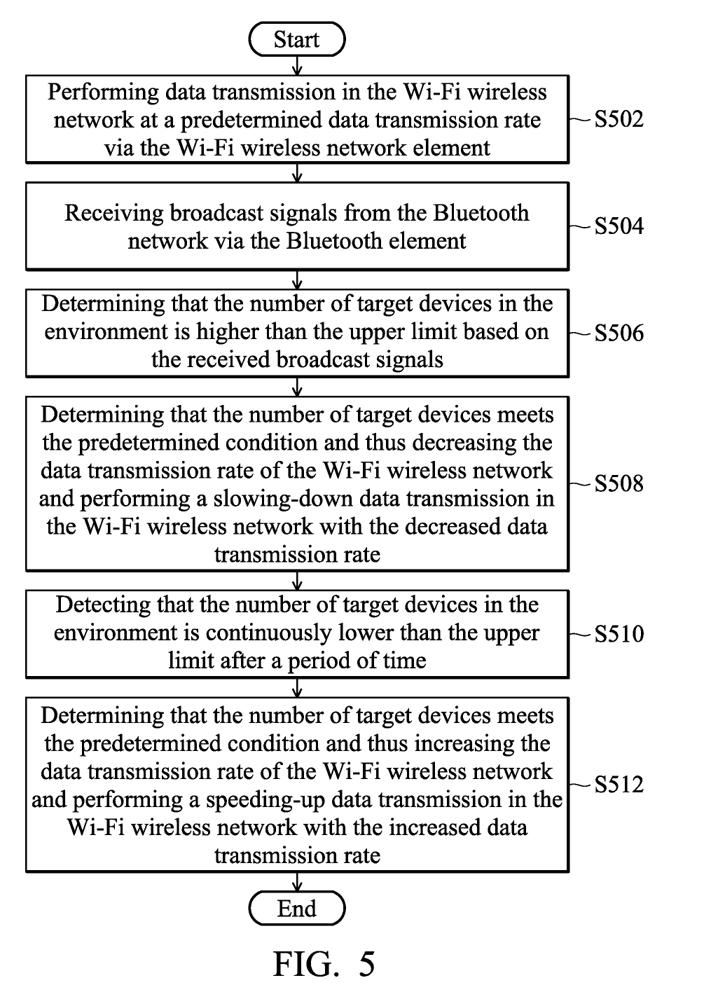

FIG. 5 is a flowchart of yet another embodiment of the method for determining the data transmission rate of the network of the invention for dynamically adjusting the data transmission rate of the network. The method for determining the data transmission rate of the network can be applied to the mobile device 100 as shown in FIG. 2. Please refer together to FIG. 1, FIG. 2 and FIG. 5. In this embodiment, it is assumed that the first network 310 is a Bluetooth network, the second network 320 is a Wi-Fi wireless network, the first network element 112 is a Bluetooth element, and the second network element 114 is a Wi-Fi wireless network components. Note that there are a number of target devices 200 communicate with the same number of mobile devices 100 in the environment 10, and each of the target devices 200 and a corresponding mobile device 100 perform the data transmission over the Wi-Fi wireless network and continue to issue broadcast signal including its identification information to the Bluetooth network via a beacon.

First, the mobile device 100 performs data transmission in the Wi-Fi wireless network at a predetermined data transmission rate via the Wi-Fi wireless network element (step S502) and receives multiple broadcast signals from the Bluetooth network via the Bluetooth element to determine the degree of congestion of the current network (step S504).

In this embodiment, it is assumed that the upper limit is set to be 10 and the mobile device 100 receives the broadcast signals sent from a total of eleven target devices 200 from the Bluetooth network. Thus, the mobile device 100 determines that the number of target devices 200 in the environment is higher than the upper limit based on the received broadcast signals (step S506) and determines that the number of target devices 200 meets the predetermined condition, so the mobile device 100 decreases the data transmission rate of the Wi-Fi wireless network and then performs a slowing-down data transmission in the Wi-Fi wireless network with the decreased data transmission rate (step S508).

The mobile device 100 continues to detect the number of target devices 200 in the environment after performing the slowing-down data transmission in the Wi-Fi wireless network at the decreased data transmission rate. After a period of time, the mobile device 100 detects that the number of target devices 200 in the environment is continuously lower than the upper limit (step S510), which indicates that the condition that the network bandwidth is insufficient has improved, and thus the mobile device 100 determines that the number of target device 200 meets the predetermined conditions, increases the data transmission rate of the Wi-Fi wireless network and then performs a speeding-up data transmission in the Wi-Fi wireless network with the increased data transmission rate (step S512).

In some embodiments, embodiments of the present invention further provide a method of determining the data transmission rate of a wireless network based on the determined target device.

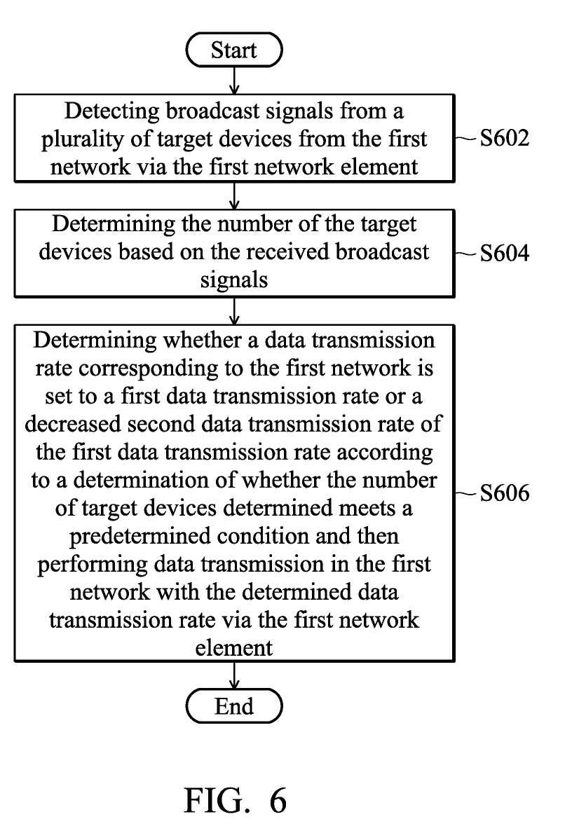

FIG. 6 is a flowchart of an embodiment of a method for determining a data transmission rate of a network of the invention. The method for determining the data transmission rate of the network can be applied to the mobile device 100 as shown in FIG. 2. For example, the method can be performed by the processor 120 of the mobile device 100 as shown in FIG. 2.

First, in step S602, the processor 120 detects broadcast signals from one or more target devices 200 from the first network 310 via the first network element 112 of the wireless module 110. To be more specific, in the embodiments of the present invention, each of the target devices 200 in use will continuously transmit a broadcast signal to the first network 310. The broadcast signal sent from each target device 200 may include identification information corresponding thereto, such as the media access control address of each target device 200. The mobile device 100 may detect all the broadcast signals via the first network element 112.

Thereafter, in step S604, the processor 120 determines the number of the target devices 200 based on the received broadcast signals. In this step, as the broadcast signal of each target device 200 contains its corresponding identification information, the processor 120 can determine the number of the target devices 200 within the environment based on the number of received broadcast signals.

After determining the number of target devices 200, in step S606, the processor 120 determines whether a data transmission rate corresponding to the first network 310 is set to a first data transmission rate or a second data transmission rate adjusted from the first data transmission rate according to a determination of whether the number of target devices determined meets a predetermined condition and then performs data transmission in the first network 310 with the determined data transmission rate via the first network element 112.

In one embodiment, the predetermined condition can be a determination of whether the number of target devices is higher than an upper limit, and the step that the processor 120 determines whether the data transmission rate corresponding to the first network 310 is set to the first data transmission rate or the second data transmission rate according to the determination of whether the number of target devices determined meets the predetermined condition may further include the following steps: determining that the data transmission rate corresponding to the first network is set to the first data transmission rate (e.g., the first data transmission rate is of a default rate of 1 kbps) when the number of the target devices 200 is not higher than the upper limit; and decreasing the first data transmission rate to generate the second data transmission rate (e.g., the second data transmission rate is of 0.5 kbps) and determining that the data transmission rate corresponding to the first network is set to the second data transmission rate when the number of the target devices 200 is higher than the upper limit.

In another embodiment, the predetermined condition may be a determination of whether the number of target devices is lower than a lower limit and the step that the processor 120 determines whether the data transmission rate corresponding to the first network 310 is set to the first data transmission rate or the second data transmission rate according to the determination of whether the number of target devices determined meets the predetermined condition may further include the following steps: determining, by the processor 120, that the data transmission rate corresponding to the first network 310 is set to the first data transmission rate (e.g., the first data transmission rate is of the default rate of 1 kbps) when the number of the target devices is not lower than the lower limit; and increasing, by the processor 120, the first data transmission rate to generate the second data transmission rate (e.g., the second data transmission rate is of 1.5 kbps) and determining that the data transmission rate corresponding to the first network 310 is set to the second data transmission rate when the number of the target devices 200 is lower than the lower limit.

Thus, according to the mobile devices supporting a plurality of networks and methods for determining the data transmission rate of the network thereof of the invention, the data transmission rate of one network can be dynamically adjusted based on the degree of network congestion detected from another network, so as to adjust the transmission speed of the data signals, thereby making smooth data transmission under the limited network bandwidth without causing network bandwidth blocking.

The embodiments of methods for determining the data transmission rate of the network that have been described, or certain aspects or portions thereof, may be practiced in logic circuits, or may take the form of program code (i.e., instructions) embodied in tangible media, such as floppy diskettes, CD-ROMS, hard drives, or any other machine-readable storage medium, wherein, when the program code is loaded into and executed by a machine such as a smartphone, a mobile phone, or a similar device, the machine becomes an apparatus for practicing the invention. The disclosed methods may also be embodied in the form of program code transmitted over some transmission medium, such as electrical wiring or cabling, through fiber optics, or via any other form of transmission, wherein, when the program code is received and loaded into and executed by a machine, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it should be understood that the invention is not limited thereto. On the contrary, it is intended to cover various modifications and similar arrangements (as would be apparent to the skilled in the art). Therefore, the scope of the appended claims should be accorded the broadest interpretation so as to encompass all such modifications and similar arrangements.

What is claimed is:

1. A method for determining a data transmission rate of a network applied to a mobile device, wherein the mobile device comprises a first network element and a second network element for connecting to a first network and a second network, respectively, the method comprising:
detecting a plurality of broadcast signals from a plurality of target devices of the first network via the first network element;
determining the number of the target devices based on the detected broadcast signals; and
determining whether a data transmission rate corresponding to the second network is set to a first data transmission rate or a second data transmission rate adjusted from the first data transmission rate according to a determination of whether the number of the target devices meets a predetermined condition and performing data transmission in the second network with the determined data transmission rate via the second network element.

2. The method of claim 1, wherein the predetermined condition is a determination of whether the number of the target devices is higher than an upper limit, and the step of determining whether the data transmission rate corresponding to the second network is set to the first data transmission rate or the second data transmission rate according to the determination of whether the number of the target devices meets the predetermined condition further comprises:
determining that the data transmission rate corresponding to the second network is set to the first data transmission rate when the number of the target devices is not higher than the upper limit; and
decreasing the first data transmission rate to generate the second data transmission rate and determining that the data transmission rate corresponding to the second network is set to the second data transmission rate when the number of the target devices is higher than the upper limit.

3. The method of claim 2, further comprising:
continuously detecting the number of the target devices after determining that the data transmission rate corresponding to the second network is set to the second data transmission rate; and
increasing the second data transmission rate to generate an increased data transmission rate and setting the data transmission rate corresponding to the second network to the increased data transmission rate when continuously detecting that the number of the target devices is not higher than the upper limit value.

4. The method of claim 1, wherein the predetermined condition is a determination of whether the number of the target devices is lower than a lower limit, and the step of determining whether the data transmission rate corresponding to the second network is set to the first data transmission rate or the second data transmission rate according to the determination of whether the number of the target devices meets the predetermined condition further comprises:
determining that the data transmission rate corresponding to the second network is set to the first data transmission rate when the number of the target devices is not lower than the lower limit; and
increasing the first data transmission rate to generate the second data transmission rate and determining that the data transmission rate corresponding to the second network is set to the second data transmission rate when the number of the target devices is lower than the lower limit.

5. The method of claim 1, further comprising:
determining a data transmission rate corresponding to the first network according to the number of the target devices; and
performing the data transmission in the first network with the determined data transmission rate via the first network element.

6. The method of claim 5, wherein the step of determining the data transmission rate corresponding to the first network according to the number of the target devices further comprises:
determining that the data transmission rate corresponding to the first network is set to a predetermined data transmission rate when the number of the target devices is not higher than an upper limit; and
decreasing the predetermined data transmission rate to generate a decreased data transmission rate and setting the data transmission rate corresponding to the first network to the decreased data transmission rate when the number of the target devices is higher than the upper limit.

7. The method of claim 1, wherein the broadcast signals comprise media access control addresses corresponding to the target devices.

8. The method of claim 1, wherein the first network element and the second network element use different communication protocols.

9. The method of claim 8, wherein the first network element is a Bluetooth element and the second network element is a wireless network element.

10. A mobile device comprising:
a wireless module for performing wireless signal transmission and reception with a plurality of target devices via a first network and a second network, respectively; and
a processor coupled to the wireless module for detecting a plurality of broadcast signals from the target devices of the first network via the wireless module, determining the number of the target devices based on the detected broadcast signals, and determining whether a data transmission rate corresponding to the second network is set to a first data transmission rate or a second data transmission rate adjusted from the first data transmission rate according to a determination of whether the number of the target devices meets a predetermined condition and performing data transmission in the second network with the determined data transmission rate via the wireless module.

11. The mobile device of claim 10, wherein the wireless module further comprises a first network element and a second network element for connecting to the first network and the second network, respectively, and the processor further detects the broadcast signals from the first network via the first network element, and the processor further performs the data transmission in the second network with the determined data transmission rate via the second network element.

12. The mobile device of claim 11, wherein the first network element and the second network element use different communication protocols.

13. The mobile device of claim 12, wherein the first network element is a Bluetooth element and the second network element is a wireless network element.

14. The mobile device of claim 10, wherein the predetermined condition is a determination of whether the number of the target devices is higher than an upper limit, and the processor further determines that the data transmission rate corresponding to the second network is set to the first data transmission rate when the number of the target devices is not higher than the upper limit and the processor further decreases the first data transmission rate to generate the second data transmission rate and determines that the data transmission rate corresponding to the second network is set to the second data transmission rate when the number of the target devices is higher than the upper limit.

15. The mobile device of claim 14, wherein the processor further continuously detects the number of the target devices after determining that the data transmission rate corresponding to the second network is set to the second data transmission rate and increases the second data transmission rate to generate an increased data transmission rate and sets the data transmission rate corresponding to the second network to the increased data transmission rate when continuously detecting that the number of the target devices is not higher than the upper limit value.

16. The mobile device of claim 10, wherein the predetermined condition is a determination of whether the number of the target devices is lower than a lower limit, and the processor further determines that the data transmission rate corresponding to the second network is set to the first data transmission rate when the number of the target devices is not lower than the lower limit, and the processor further increases the first data transmission rate to generate the second data transmission rate and determines that the data transmission rate corresponding to the second network is set to the second data transmission rate when the number of the target devices is lower than the lower limit.

17. The mobile device of claim 10, wherein the processor further determines a data transmission rate corresponding to the first network according to the number of the target devices and performs the data transmission in the first network with the determined data transmission rate via the wireless module.

18. The mobile device of claim 10, wherein the broadcast signals comprise media access control addresses corresponding to the target devices.

19. The mobile device of claim 10, wherein the processor further performs the data transmission with one of the target devices in the second network at the determined data transmission rate.

20. The mobile device of claim 10, wherein the mobile device is a hand-held device or a portable device.
